(19) United States
(12) Patent Application Publication
(10) Pub. No.: US 2026/0005924 A1
(43) Pub. Date: Jan. 1, 2026

(54) SYSTEM AND METHOD FOR NETWORK SLICING CONTINUITY PROVISIONING ACROSS NETWORK OPERATORS

(71) Applicant: JIO PLATFORMS LIMITED, Ahmedabad (IN)

(72) Inventors: Aayush BHATNAGAR, Navi Mumbai (IN); Apoorva KHAMESRA, Udaipur (IN); Tarun MAHESHWARI, Pune (IN)

(73) Assignee: JIO PLATFORMS LIMITED, Ahmedabad (IN)

(21) Appl. No.: 18/869,194

(22) PCT Filed: May 31, 2023
(86) PCT No.: PCT/IB2023/055559

§ 371 Date: Nov. 25, 2024

(30) Foreign Application Priority Data
May 31, 2022 (IN) 202221031237

(51) Int. Cl. H04L 41/0895; H04W 28/02; H04W 48/16; H04W 48/18; H04W 84/04

(52) U.S. Cl. CPC H04L 41/0895; H04W 28/0268; H04W 48/16; H04W 48/18; H04W 84/042

(57) ABSTRACT

The present disclosure provides a system and a method for network slicing continuity provisioning across network operators. The system receives a roaming request based on a quality of service (QOS) request provided by various users in a home public land mobile network (HPLMN). The system provisions a network slice in a visitor public land mobile network (VPLMN) based on the roaming request from the users. The system enables the users to access the VPLMN upon roaming.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for core network slicing in a telecommunications network. More particularly, the present disclosure relates to a system and a method for network slicing continuity provisioning across network operators.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Roaming extends coverage of a home operator's voice and short message services (SMS), allowing a mobile user to continue using their home operator phone number and data services in another geographical location or country. The extension of coverage is enabled by a roaming agreement between a mobile user's home operator and a visited mobile operator network. This is similar to an inter-operator arrangement like an international roaming service. The roaming agreement provides technical and commercial components required for enabling services in another country. However, roaming services have to be efficiently implemented to provide data services in another country.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that provides network slicing continuity across network operators, when customers roam from one geographical location to another.

It is an object of the present disclosure to provide a system and a method that enables a home public land mobile network (HPLMN) to have network slicing continuity across network operators, when customers roam from one geographical location to another.

It is an object of the present disclosure to provide a system and a method that provides an on demand slice provisioning in a visitor network.

It is an object of the present disclosure to provide a system and a method that creates a network slice in the visitor network and enables customers to access mobile services through the visitor network.

It is an object of the present disclosure to enhance user experience.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for network slicing. The system includes a processor, and a memory operatively coupled to the processor, where the memory stores instructions to be executed by the processor. The processor receives a request from one or more users via a computing device. The request is based on a quality of service (QoS) request generated by the users. The computing device is connected to the processor via a primary network. The processor determines if an end-to-end logical network is accessible in a secondary network to the one or more users based on the primary network being inaccessible to the one or more users upon roaming. The processor, in response to a positive determination, generates a mapping between the primary network and the secondary network. The processor, in response to a negative determination, provisions the end-to-end logical network in the secondary network and generates the mapping between the primary network and the secondary network. The processor enables the one or more users to access the primary network and the secondary network and facilitate generation of the network slice.

In an embodiment, the primary network may be a Home Public Land Mobile Network (HPLMN) and the secondary network may be a Visited Public Land Mobile Network (VPLMN).

In an embodiment, the processor may use a security edge protection proxy (SEPP) to provision the end-to-end logical network in the secondary network.

In an embodiment, the processor may send a discovery request to a visitor network repository function (VNRF) of the secondary network via the SEPP to provision the end-to-end logical network in the secondary network.

In an embodiment, the mapping may be a network slice selection assistance information (NSSAI) mapping.

In an embodiment, the NSSAI mapping may include anHPLMN information, an NSSAI information, and a subscription data information of the one or more users.

In an embodiment, the processor may generate an NSSAI mapping creation request to a visitor network service provider (VNSP) of the secondary network in response to the negative determination.

In an aspect, the present disclosure relates to a method for network slicing. The method includes receiving, by a processor associated with a system, a request from one or more users via a computing device. The request is based on a QoS request generated by the one or more users. The method includes determining, by the processor, if an end-to-end logical network is accessible in a secondary network to the one or more users based on the primary network being inaccessible to the one or more users upon roaming. The method includes, in response to a positive determination, generating, by the processor, a mapping between the primary network and the secondary network. The method includes, in response to a negative determination, provisioning, by the processor, the end-to-end logical network in the secondary network and generating the mapping between the primary network and the secondary network. The method includes enabling, by the processor, the one or more users to access the primary network and the secondary network, and facilitating generation of the network slice.

In an embodiment, the method may include using, by the processor, an SEPP to provision the end-to-end logical network in the secondary network.

In an embodiment, the method may include sending, by the processor, a discovery request to a VNRF of the secondary network via the SEPP to provision the end-to-end logical network in the secondary network.

In an embodiment, the mapping may be an NSSAI mapping.

In an embodiment, the NSSAI mapping may include anHPLMN information, an NSSAI information, and a subscription data information of the one or more users.

In an embodiment, the method may include generating, by the processor, an NSSAI mapping creation request to a VNSP of the secondary network in response to the negative determination.

In an aspect, a user equipment (UE) for network slicing includes one or more processors communicatively coupled to a processor in a system. The one or more processors are coupled with a memory and said memory stores instructions to be executed by the one or more processors. The one or more processors transmit a request to the processor via a network. The request is based on a QoS request generated by one or more users. The one or more users are connected to a primary network via the UE. The processor receives the request from the UE. The processor determines if an end-to-end logical network is accessible in a secondary network to the one or more users based on the primary network being inaccessible to the one or more users upon roaming. In response to a positive determination, the processor generates a mapping between the primary network and the secondary network. In response to a negative determination, the processor provisions the end-to-end logical network in the secondary network and generates the mapping between the primary network and the secondary network. The processor enables the one or more users to access the primary network and the secondary network, and facilitate generation of the network slice.

In an aspect, a non-transitory computer readable medium includes a processor with executable instructions that cause the processor to receive a user request from one or more users via a computing device. The request is based on a QoS request generated by the one or more users. The processor determines if an end-to-end logical network is accessible in a secondary network to the one or more users based on a primary network being inaccessible to the one or more users upon roaming. In response to a positive determination, the processor generates a mapping between the primary network and the secondary network. In response to a negative determination, the processor provisions the end-to-end logical network in the secondary network and generates the mapping between the primary network and the secondary network. The processor enables the one or more users to access the primary network and the secondary network, and facilitate generation of the network slice.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) for implementing a proposed system (110), in accordance with an embodiment of the present disclosure.

FIG. 2 illustrates an exemplary block diagram (200) of a proposed system (110), in accordance with an embodiment of the present disclosure.

FIG. 3 illustrates an exemplary system architecture (300) of a network slicing platform (NSP), in accordance with an embodiment of the present disclosure.

FIG. 4 illustrates an exemplary registration process (400) of the NSP with a network resource function (NRF), in accordance with an embodiment of the present disclosure.

FIG. 5 illustrates an exemplary roaming flow diagram (500) of a user equipment (UE) from a home public land mobile network (HPLMN) to a visitor public land mobile network (VPLMN), in accordance with an embodiment of the present disclosure.

FIG. 6 illustrates an exemplary roaming flow diagram (600) with a creation of network slice in the VPLMN, in accordance with an embodiment of the present disclosure.

FIG. 7 illustrates an exemplary computer system (700) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

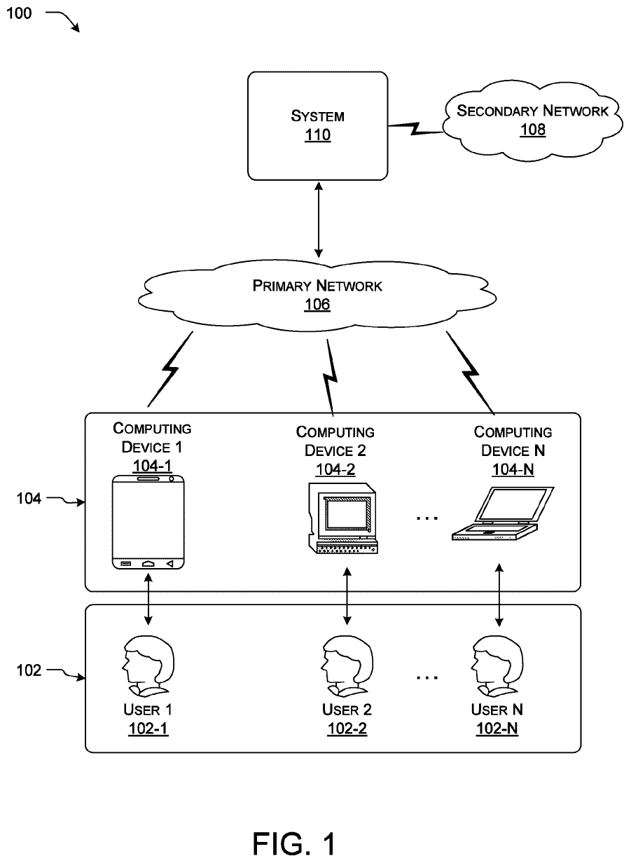

The various embodiments throughout the disclosure will be explained in more detail with reference to FIGS. 1-7.

FIG. 1 illustrates an exemplary network architecture (100) for implementing a proposed system (110), in accordance with an embodiment of the present disclosure.

As illustrated in FIG. 1, the network architecture (100) may include a system (110). The system (110) may be connected to one or more computing devices (104-1, 104-2 . . . 104-N) via a primary network (106). The one or more computing devices (104-1, 104-2 . . . 104-N) may be interchangeably specified as a user equipment (UE) (104) and be operated by one or more users (102-1, 102-2 . . . 102-N). Further. the one or more users (102-1, 102-2 . . . 102-N) may be interchangeably referred as a user (102) or users (102). In an embodiment, the system (110) may be interchangeably referred as a network slicing platform (NSP). The system (110) may provide a network slice in a secondary network (108) to enable a roaming facility to the user (102) when the user (102) travels from one geographic location to another geographic location.

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the primary network (106) and/or the secondary network (108) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The primary network (106) and/or the secondary network (108) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (110) may receive a request from the one or more users (102) via the computing device (104). The request may be based on a quality of service (QOS) request generated by the users (102). The system (110) may determine if an end-to-end logical network/network slice is accessible in the secondary network (108) to the one or more users (102) based on the primary network (106) being inaccessible to the one or more users (102) upon roaming. In an embodiment, the primary network (106) may be a Home Public Land Mobile Network (HPLMN) and the secondary network (108) may be a Visited Public Land Mobile Network (VPLMN).

In an embodiment, in response to a positive determination, the system (110) may generate a mapping between the primary network (106) and the secondary network (108). In response to a negative determination, the system (110) may provision the end-to-end logical network in the secondary network (108) and generate the mapping between the primary network (106) and the secondary network (108). The system (110) may use a security edge protection proxy (SEPP) to provision the end-to-end logical network in the secondary network (108).

In an embodiment, the mapping generated by the system (110) may be a network slice selection assistance information (NSSAI) mapping. The NSSAI mapping may include anHPLMN information, an NSSAI information, and a subscription data information of the one or more users (102). The system (110) may generate an NSSAI mapping creation request to a visitor network service provider (VNSP) of the secondary network (108) upon the negative determination.

In an embodiment, the system (110) may send a discovery request to a visitor network repository function (VNRF) of the secondary network (108) via the SEPP to provision the end-to-end logical network in the secondary network (108). The system (110) may enable the one or more users (102) to access the primary network (106) and the secondary network (108).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

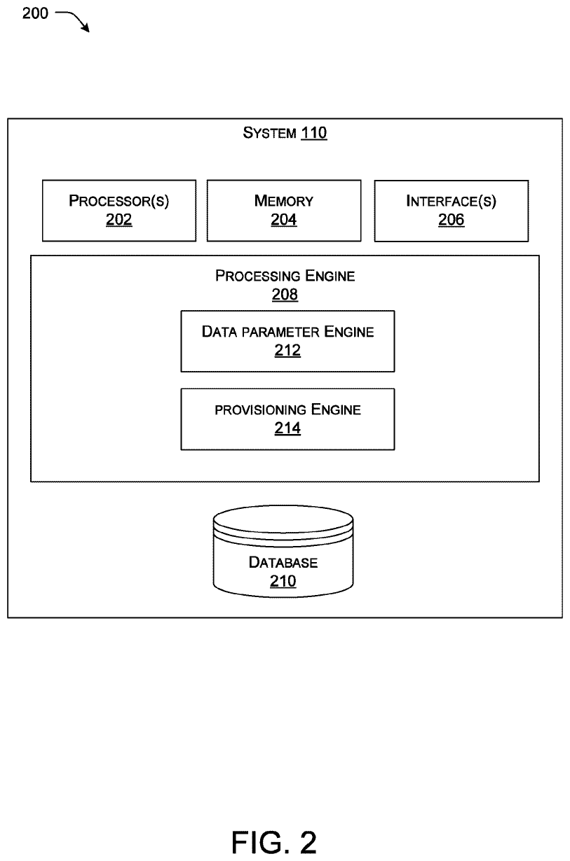

FIG. 2 illustrates an exemplary block diagram (200) of a proposed system (110), in accordance with an embodiment of the present disclosure.

Referring to FIG. 2, the system (110) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (110). Examples of such components include, but are not limited to, processing engine(s) (208) and a database (210), where the processing engine(s) (208) may include, but not be limited to, a data parameter engine (212) and a provisioning engine (214).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive a request from one or more users (102) via the data parameter engine (212). The request may be sent by the one or more users (102) via a computing device (104). The processor (202) may store the received request in the database (210). The request may be based on a QoS request generated by the users (102). The processor (202) may determine if an end-to-end logical network is accessible in a secondary network (108) to the one or more users (102) based on the primary network (106) being inaccessible to the one or more users (102) upon roaming.

In an embodiment, in response to a positive determination, the processor (202) may generate a mapping between the primary network (106) and the secondary network (108). In response to a negative determination, the processor (202) may provision the end-to-end logical network in the secondary network (108) via the provisioning engine (214). The processor (202) may generate the mapping between the primary network (106) and the secondary network (108). The processor (202) may use an SEPP to provision the end-to-end logical network in the secondary network (108).

In an embodiment, the mapping generated by the processor (202) may be an NSSAI mapping. The NSSAI mapping may include anHPLMN information, an NSSAI information, and a subscription data information of the one or more users (102). The processor (202) may generate an NSSAI mapping creation request to a VNSP of the secondary network (108) upon the negative determination.

In an embodiment, the processor (202) may send a discovery request to a VNRF of the secondary network (108) via the SEPP to provision the end-to-end logical network in the secondary network (108). The processor (202) may enable the one or more users (102) to access the primary network (106) and the secondary network (108).

Although FIG. 2 shows exemplary components of the system (110). in other embodiments, the system (110) may include fewer components, different components, differently arranged components, or additional functional components than depicted in FIG. 2. Additionally, or alternatively, one or more components of the system (110) may perform functions described as being performed by one or more other components of the system (108).

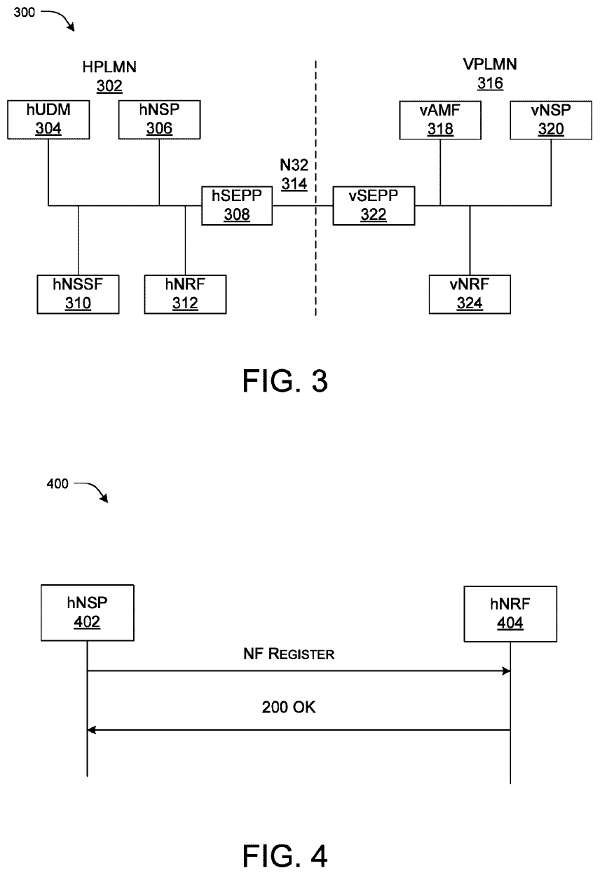

FIG. 3 illustrates an exemplary system architecture (300) of a network slicing platform (NSP), in accordance with an embodiment of the present disclosure.

In an embodiment, the system/NSP (110) may create a network slice/an end-to-end logical network with a specific configuration in a home PLMN (302) and a roaming VPLMN network (316). The communication between a home network service platform (hNSP) (306) and a visitor network service platform (vNSP) (320) may be provisioned by an SEPP (308, 322) configured in the system (110).

In an embodiment, the HPLMN (302) may include a home unified data management (hUDM) (304), the hNSP (306), a home security edge protection proxy (hSEPP) (308), a home network slice selection function (hNSSF) (310), and a home network resource function (hNRF) (312). The hSEPP (308) may be connected to a visitor security edge selection proxy (vSEPP) (322) via an interface N32 (314).

In an embodiment, the VPLMN (316) may include a visited access and mobility management function (vAMF) (318), a visitor network service function (vNSP) (320), the vSEPP (322), and a visitor network resource function (vNRF) (324).

In an embodiment, the system (110) may integrate with the hSEPP (308) and forward messages to the vNRF (324) and the vNSP (320), and vice versa. The system (110) may receive the request from a user (102) for providing network slice mapping. The system (110) may enable network slice provisioning in different network functions such as, but not limited to, an AMF, a session management function (SMF), a network slice selection function (NSSF), and a user plane function (UPF).

FIG. 4 illustrates an exemplary registration process (400) of the NSP with a network resource function (NRF), in accordance with an embodiment of the present disclosure.

As illustrated in FIG. 4, an hNSP (402) may send a network function (NF) register request to an hNRF (404). In an embodiment, the hNSP (402) may register itself with the hNRF (404) as a network function and support service operations. The hNRF (404) may send a 200 OK response.

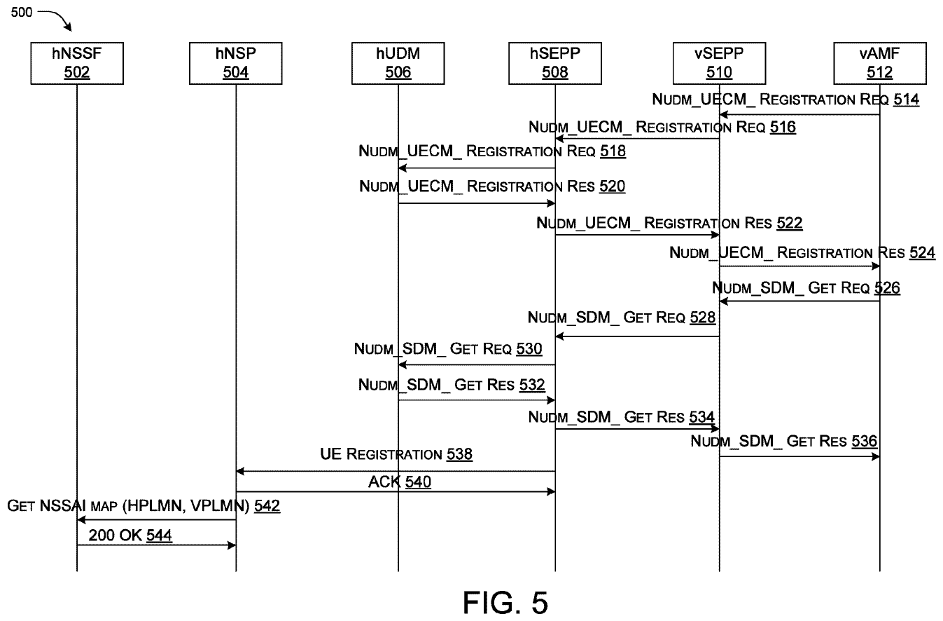

FIG. 5 illustrates an exemplary roaming flow diagram (500) of a UE from an HPLMN to a VPLMN, in accordance with an embodiment of the present disclosure.

As illustrated in FIG. 5, the following steps may be implemented.

At step 514: A vAMF (512) may send a nudm_UECM_registration request to a vSEPP (510).

At step 516: The vSEPP (510) may send the nudm_UECM_registration request to an hSEPP (508).

At step 518: The hSEPP (508) may forward the nudm_UECM_registration request to an hUDM (506).

At step 520: The hUDM (506) may send a nudm_UECM_registration response to the hSEPP (508).

At step 522: The hSEPP (508) may further send the nudm_UECM_registration response to the vSEPP (510).

At step 524: The vSEPP (510) may forward the nudm_UECM_registration response to the vAMF (512).

At step 526: The vAMF (512) may send a nudm_SDM_get request to the vSEPP (510).

At step 528: The vSEPP (510) may send the nudm_SDM_get request to the hSEPP (508).

At step 530: The hSEPP (508) may forward the nudm_SDM_get request to the hUDM (506).

At step 532: The hUDM (506) may send a nudm_SDM_get response to the hSEPP (508).

At step 534: The hSEPP (508) may send the nudm_SDM_get response to the vSEPP (510).

At step 536: The vSEPP (510) may forward the nudm_SDM_get response to the vAMF (512).

At step 538: The hSEPP (508) may send a UE registration request to an hNSP (504).

At step 540: The hNSP (504) may send an acknowledgement to the hSEPP (508).

At step 542: The hNSP (504) may send a get NSSAI map information (HPLMN, VPLMN) to an hNSSF (502).

At step 544: The hNSSF (502) may send an ok response to the hNSP (504).

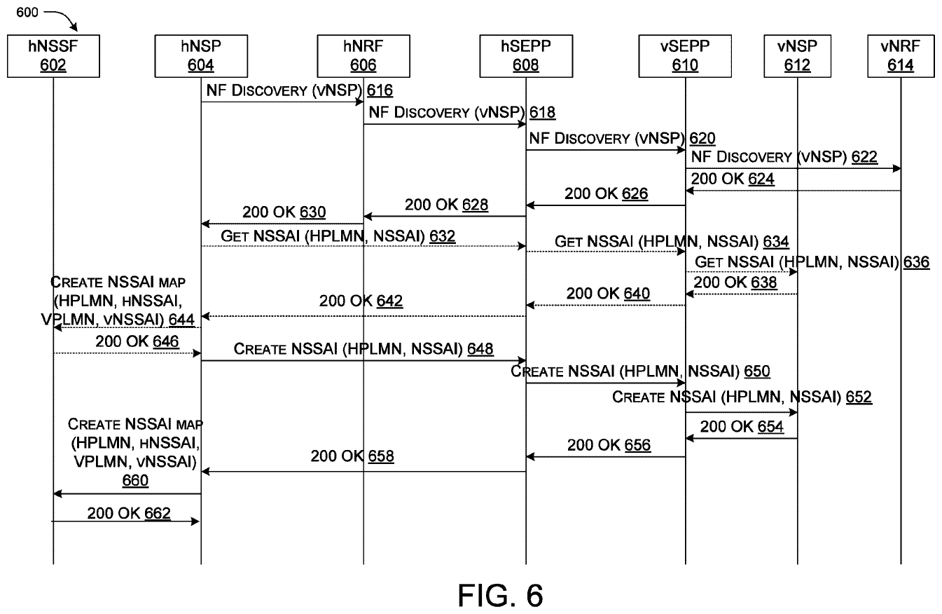

FIG. 6 illustrates an exemplary roaming flow diagram (600) with a creation of network slice in the VPLMN, in accordance with an embodiment of the present disclosure.

As illustrated in FIG. 6, the following steps may be implemented.

At step 616: An hNSP (604) may send an NF Discovery (vNSP) to an hNRF (606).

At step 618: The hNRF (606) may send the NF Discovery (vNSP) to an hSEPP (608).

At step 620: The hSEPP (608) may send the NF Discovery (vNSP) to a vSEPP (610).

At step 622: The vSEPP (610) may send the NF Discovery (vNSP) to a vNRF (614).

At step 624: The vNRF (614) may send an ok response to the vSEPP (610).

At step 626: The vSEPP (610) may end the ok response to the hSEPP (608).

At step 628: The hSEPP (608) may send the ok response to the hNRF (606).

At step 630: The hNRF (606) may send the ok response to the hNSP (604).

At step 632: The hNSP (604) may send a get NSSAI map information (HPLMN, NSSAI) to the hSEPP (608).

At step 634: The hSEPP (608) may send the get NSSAI map information (HPLMN, NSSAI) to the vSEPP (610).

At step 636: The vSEPP (610) may send the get NSSAI map information (HPLMN, NSSAI) to a vNSP (612).

At step 638: The vNSP (612) may send an ok response to the vSEPP (610).

At step 640: The vSEPP (610) may send the ok response to the hSEPP (608).

At step 642: The hSEPP (608) may send the ok response to the hNSP (604).

At step 644: The hNSP (604) may send a create NSSAI map (HPLMN, hNSSAI, VPLMN, vNSSAI) to an hNSSF (602).

At step 646: The hNSSF (602) may send an ok response to the hNSP (604).

At step 648: The hNSP (604) may send a create request (HPLMN, NSSAI) to the hSEPP (608).

At step 650: The hSEPP (608) may send the create request (HPLMN, NSSAI) to the vSEPP (610).

At step 652: The vSEPP (610) may send the create request (HPLMN, NSSAI) to the vNSP (612).

At step 654: The vNSP (612) may send an ok response to the vSEPP (610).

At step 656: The vSEPP (610) may send the ok response to the hSEPP (608).

At step 658: The hSEPP (608) may send the ok response to the hNSP (604).

At step 660: The hNSP (604) may send the create NSSAI map information (HPLMN, hNSSAI, VPLMN, vNSSAI) to the hNSSF (602).

At step 662: The hNSSF (602) may send an ok response to the hNSP (604).

In an embodiment, if the network slice is not present, the hNSP (604) may send the discovery request based on the network slice from the vNSP (612) to hNRF (606). The hNRF (606) may forward the discovery request to the vNRF (612) via the hSEPP (608) and the vSEPP (610) while the vNRF (612) may send a response back.

In an embodiment, in case the discovery request is for a standard slice, the hNSP (604) may send the GET NSSAI request to the vNSP (612) which may include the HPLMN and NSSAI details and the vNSP (612) may provide the response to the hNSP (604).

In an embodiment, if the network slice is available in the VPLMN, the NSSAI mapping may be created in the hNSSF (602). The hNSP (604) may send the create NSSAI map request to the hNSSF (602) which may include the HPLMN, the VPLMN, the hNSSAI, and the vNSSAI details. The hNSSF (602) may create the network slice mapping and confirm back to the hNSP (604).

In an embodiment, if the network slice is not available, the hNSP (604) may send a create NSSAI to the vNSP (612) via the hSEPP (608) and the vSEPP (610). This request may include the HPLMN, the NSSAI, and subscription data information. The vNSP (612) may provision the network slice and send the confirmation to the hNSP (604). The hNSP (604) may send the create NSSAI map request to the hNSSF (602), which may include the HPLMN, the VPLMN, the hNSSAI, and vNSSAI details. The hNSSF (602) may create the network slice mapping and confirm back to the hNSP (604).

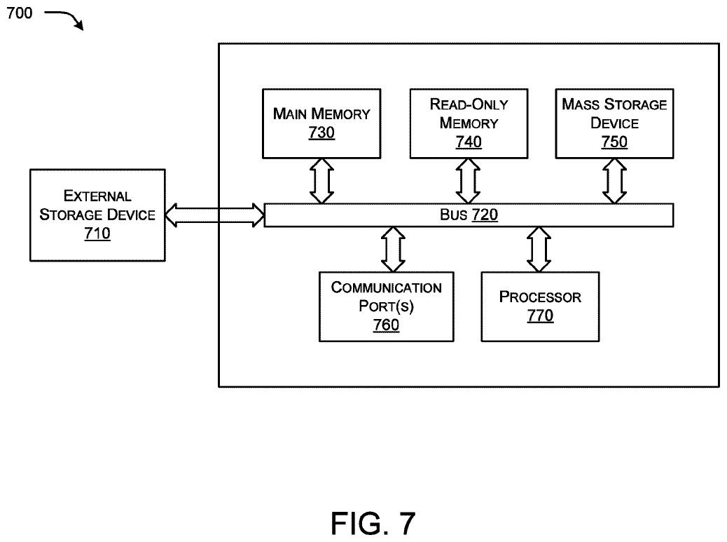

FIG. 7 illustrates an exemplary computer system (700) in which or with which embodiments of the present disclosure may be implemented.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection. a 10/100 Ethernet port, a Gigabit or 10 Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) may communicatively couple the processor(s) (770) with the other memory, storage, and communication blocks. The bus (720) may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). Components described above are meant only to exemplify various possibilities. In no way should the aforementioned exemplary computer system (700) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method that provides network slicing continuity across network operators, when customers roam from one geographical location to another.

The present disclosure provides a system and a method that enables a home public land mobile network (HPLMN) to have network slicing continuity across network operators, when customers roam from one geographical location to another.

The present disclosure provides a system and a method that provides an on demand slice provisioning in a visitor network.

The present disclosure provides a system and a method that creates a network slice in the visitor network and enables customers to access mobile services through the visitor network.

The present disclosure provides a system and method to enhance the communication system.

We claim:

1. A system (110) for network slicing the system (110) comprising:
a processor (202); and
a memory (204) operatively coupled with the processor (202), wherein said memory (204) stores instructions which, when executed by the processor (202), cause the processor (202) to:
receive a request from one or more users (102) via a computing device (104), wherein the request is based on a quality of service (QOS) request generated by the users (102), and wherein the computing device (104) is connected to the processor (202) via a primary network (106);
determine if an end-to-end logical network is accessible in a secondary network (108) to the one or more users (102) based on the primary network (106) being inaccessible to the one or more users (102) upon roaming;
in response to a positive determination, generate a mapping between the primary network (106) and the secondary network (108);
in response to a negative determination, provision the end-to-end logical network in the secondary network (108) and generate the mapping between the primary network (106) and the secondary network (108); and
enable the one or more users (102) to access the primary network (106) and the secondary network (108), and facilitate generation of the network slice.

2. The system (110) as claimed in claim 1, wherein the primary network (106) is a Home Public Land Mobile Network (106), and wherein the secondary network (108) is a Visited Public Land Mobile Network (108).

3. The system (110) as claimed in claim 1, wherein the processor (202) is to use a security edge protection proxy (SEPP) to provision the end-to-end logical network in the secondary network (108).

4. The system (110) as claimed in claim 3, wherein the processor (202) is to send a discovery request to a visitor network repository function (VNRF) of the secondary network (108) via the SEPP to provision the end-to-end logical network in the secondary network (108).

5. The system (110) as claimed in claim 1, wherein the mapping is a network slice selection assistance information (NSSAI) mapping.

6. The system (110) as claimed in claim 5, wherein the NSSAI mapping comprises a home public land mobile network (HPLMN) information, an NSSAI information, and a subscription data information of the one or more users (102).

7. The system (110) as claimed in claim 1, wherein the processor (202) is to generate a network slice selection assistance information (NSSAI) mapping creation request to a visitor network service provider (VNSP) of the secondary network (108) in response to the negative determination.

8. A method for network slicing, the method comprising:
receiving, by a processor (202) associated with a system (110), a request from one or more users (102) via a computing device (104), wherein the request is based on a quality of service (QOS) request generated by the one or more users (102);
determining, by the processor (202), if an end-to-end logical network is accessible in a secondary network (108) to the one or more users (102) based on a primary network (106) being inaccessible to the one or more users (102) upon roaming;
in response to a positive determination, generating, by the processor (202), a mapping between the primary network (106) and the secondary network (108);
in response to a negative determination, provisioning, by the processor (202), the end-to-end logical network in the secondary network (108) and generating the mapping between the primary network (106) and the secondary network (108); and
enabling, by the processor (202), the one or more users (102) to access the primary network (106) and the secondary network (108), and facilitating generation of the network slice.

9. The method as claimed in claim 8, comprising using, by the processor (202), a security edge protection proxy (SEPP) to provision the end-to-end logical network in the secondary network (108).

10. The method as claimed in claim 9, comprising sending, by the processor (202), a discovery request to a visitor network repository function (VNRF) of the secondary network (108) via the SEPP to provision the end-to-end logical network in the secondary network (108).

11. The method as claimed in claim 8, wherein the mapping is a network slice selection assistance information (NSSAI) mapping.

12. The method as claimed in claim 11, wherein the NSSAI mapping comprises a home public land mobile network (HPLMN) information, an NSSAI information, and a subscription data information of the one or more users (102).

13. The method as claimed in claim 8, comprising generating, by the processor (202), a network slice selection assistance information (NSSAI) mapping creation request to a visitor network service provider (VNSP) of the secondary network (108) in response to the negative determination.

14. A user equipment (UE) (104) for network slicing, the UE (104) comprising:
one or more processors communicatively coupled to a processor (202) associated with a system (110), wherein the one or more processors are coupled with a memory, and wherein said memory stores instructions which, when executed by the one or more processors, cause the one or more processors to:
transmit a request to the processor (202) via a network (106), wherein the request is based on a quality of service (QOS) report generated by one or more users (102),
wherein the processor (202) is configured to:
receive the request from the UE (104);
determine if an end-to-end logical network is accessible in a secondary network (108) to the one or more users (102) based on a primary network (106) being inaccessible to the one or more users (102) upon roaming;
in response to a positive determination, generate a mapping between the primary network (106) and the secondary network (108);
in response to a negative determination, provision the end-to-end logical network in the secondary network (108) and generate the mapping between the primary network (106) and the secondary network (108); and
enable the one or more users (102) to access the primary network (106) and the secondary network (108), and facilitate generation of the network slice.

15. A non-transitory computer readable medium comprising a processor with executable instructions, causing the processor to:
receive a request from one or more users (102) via a computing device (104), wherein the request is based on a quality of service (Qos) report generated by the one or more users (102);
determine if an end-to-end logical network is accessible in a secondary network (108) to the one or more users (102) based on a primary network (106) being inaccessible to the one or more users (102) upon roaming;
in response to a positive determination, generate a mapping between the primary network (106) and the secondary network (108);
in response to a negative determination, provision the end-to-end logical network in the secondary network (108) and generate the mapping between the primary network (106) and the secondary network (108); and
enable the one or more users (102) to access the primary network (106) and the secondary network (108), and facilitate generation of the network slice.
